(19) United States
(12) Patent Application Publication
(10) Pub. No.: US 2006/0226614 A1
(43) Pub. Date: Oct. 12, 2006

(54) Cover For An Elongated Handle

(76) Inventors: Margo K. Brilliant, Miami, FL (US); Robert M. Schwartz, Miami, FL (US)

Correspondence Address: ROBERT M. SCHWARTZ, P.A., P.O. BOX 221470, HOLLYWOOD, FL, 33022, US

(21) Appl. No.: 11/278,852

(22) Filed: Apr. 6, 2006

Related U.S. Application Data
(60) Provisional application No. 60/668,648, filed on Apr. 6, 2005.

(51) Int. Cl. B62D 39/00

(52) U.S. Cl. 280/33.992

(57) ABSTRACT

The present invention is a paper cover having a curl, for placement on an elongated handle of a shopping cart so that the user of the cart does not have to touch the handle of the cart that may have come in contact with germs or dirt of a prior user, the cover is designed to have a curl such that the paper material will tend to conform to the handle of the cart, the cover may include an antimicrobial material.

### CROSS-REFERENCE TO RELATED APPLICATION

This application claims the benefit of U.S. Provisional Patent Application Ser. No. 60/668,648, filed on Apr. 6, 2005, entitled HANDLE WRAPPER; the prior application is herewith incorporated by reference in its entirety.

### BACKGROUND OF THE INVENTION

1. Field of the Invention

The present invention is a cover for an elongated handle of a shopping cart, typically used in grocery stores or other similar stores, that provide such a cart for customers, or other similar carts used by the public, such as in airports, for luggage handling situations, where the user of the cart holds a handle of the cart that has previously been used or touched by a prior user. The present cover provides a clean surface, covering the handle so the present user can avoid touching the handle, touched by a previous user which may have been dirtied or contain disease causing bacteria, germs or other harmful matter as a result of prior use.

2. Description of the Related Prior Art

There are many reasons why a second user may desire not to directly touch a handle used by a prior first user including health and sanitary reasons. Some have attempted to provide washing solutions in close proximity to the area where a new user would select a shopping cart. However these washing solutions are wet and messy and require an applicator to apply the washing solution to the handle of the shopping cart. Disposal of the applicator causes for example an unsightly mess. Others have provided covers for the entire cart or portions of the cart. However these covers are bulky, and are not generally disposable. Some companies even provide bacteria shopping cart washers.

### SUMMARY OF THE INVENTION

The present invention is related to shopping carts. Shopping carts were invented in the 1930's with the advent of the supermarket, when shoppers needed more than a hand held bag to carry their groceries. In the 1940's shopping carts acquired most of the features we are familiar with today. In 1947, the carts were first nested. Notwithstanding different materials of wire and plastic, all shopping carts have a handle.

The present invention is a cover, which preferably may be made of a thin material, such as paper, a paper like material, or of plastic, for placement around the elongated shopping cart handle. The cover is preferably disposable, for one time use by a present user, and is inexpensive.

Typically, a store such as a grocery store will have hundreds of carts, which are generally stored and located at an entrance of the store. The exact location will most likely be in a convenient setting for shoppers to select a shopping cart when they enter the store. Since shopping carts are generally substantial in construction, of steel and wire or heavy plastic materials, they are re-used continuously by the store. When shopping, a user will push the cart through the store, up and down aisles, while loading goods into the cart. The shopper will hold and direct or steer the cart, using the cart's elongated handle, which is usually an integral part of the cart. Thus each user, typically holds the handle with their hands, contacting it—usually with uncovered hands—to push and steer the cart. Each user holds the handle many times as the cart is moved from location to location throughout the store during the shopping process.

It is often considered to be unhealthy to hold a handle when another person has touched and in most cases recently touched or come in contact with the handle. Additionally, external elements, such as the weather, outside matter etc. come in contact with the handle. Thus there is a rapid spread of germs from the handle, transferred from one person—a first cart user—to another person—a second cart user.

There is also provided a dispenser of the present invention at or near a storage area. The covering of the handle is accomplished with a sheet of paper or other material, cut to size, so that the covering, can be easily applied to the shopping cart handle. The coverings are dispensed from a roll of coverings that may or may not be within a dispenser container. In this manner, when a new user is about to use the shopping cart, this second cart user can apply a covering to the handle that was previously touched by a prior user or users of the cart. The new user thus has a clean area to touch when holding the handle of the shopping cart.

Thus the present invention also provides for a novel way of dispensing the covers of the present invention for easy removal of the cover from its stored position. After use, the cover is preferably removed from the handle by disengaging the releasable adhesive. The cover is then disposed as any other waste paper or material, preferably in a waste container.

Whether the covering from the dispenser is sterile or not, the new user can hold the handle without concern of touching and coming in contact with the same handle previously touched by another. This eliminates the transfer of germs and other dirt from an area a prior user came in contact with to a present user.

The cover may include coatings to limit moisture and/or to kill harmful germs, such coatings may be antimicrobial coatings. Additional coatings may cause the cover to curl, such that the cover will curl around the handle, when placed on the handle. The curl may also be created by the construction of the cover material, as is known in the art.

These and other aspects and features of the invention are described in more detail below and are illustrated in the accompanying drawings.

### BRIEF DESCRIPTION OF THE DRAWINGS

Referring to the drawings which are made a part hereof this application,

FIG. 1. is a top view of a portion of a shopping cart showing the handle portion of said cart.

FIG. 2. is a sectional view taken along lines 2-2 of FIG. 1. showing a cross-section of a shopping cart the handle.

FIG. 3. is a cross sectional view of a portion of a roll of covers of the present invention to be dispensed for use, showing the arrangement of the said covers in end to end relationship.

FIG. 4. is a sectional view of a single cover of the present invention showing the first end and the second end, and an adhesive.

FIG. 5. is a rear view of a portion of a shopping cart, the present invention, showing how an advertisement printed on the cover of the present invention would be displayed.

FIG. 6. is a cross sectional view of a preferred embodiment of the present invention, showing the relationship of the cover with the handle such that the two ends of the cover are positioned below the handle, positioning the advertisement in a preferred position for viewing.

FIG. 7 is a schematic view of a shopping cart, with a handle.

FIG. 8 is a sectional view of an alternative embodiment of the cover of the present invention having the adhesive on the second end.

FIG. 9 is an alternate embodiment showing the covers in a stacked relationship.

FIG. 10 is a view of the handle 11 with more than one cover 13 around it.

### DETAILED DESCRIPTION OF THE PREFERRED EMBODIMENT

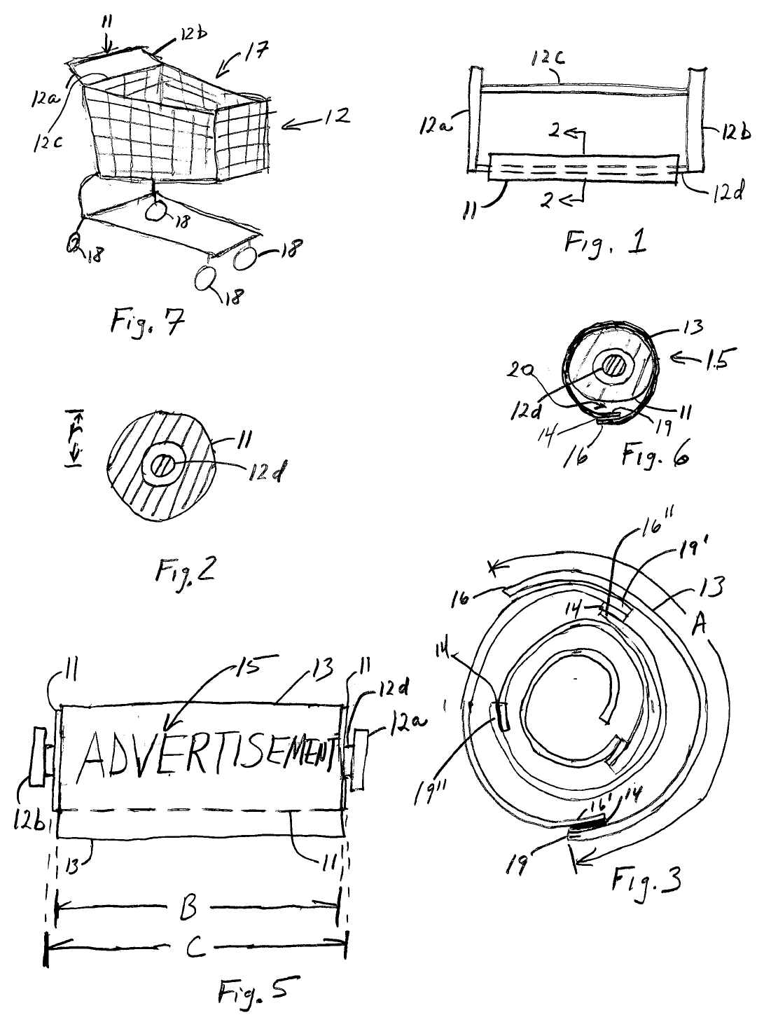

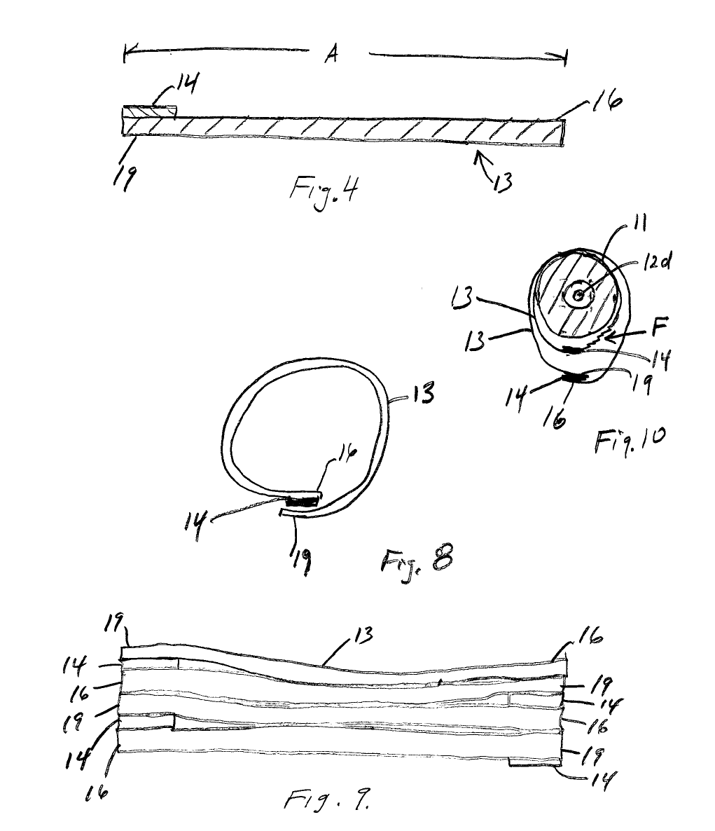

In the present invention, reference is made to a cart such as a shopping cart 12 as shown in FIG. 7., having a handle 11 generally at the rear of the cart and an open storage area 17 to receive items that shoppers are purchasing, generally for short term storage. Cart 12 has wheels 18, usually three or four wheels so that cart 12 is balanced while being pushed, and guided by the user holding handle 11. Typically handle 11 will be of plastic or wood, is generally cylindrical and will be supported on a wire structure of cart 12. A typical handle 11 as shown in FIG. 1. is supported by a pair of cart arms 12a and 12b extending from the cart cage area 12c. Handle 11 is elongated, generally cylindrical and is threaded on support 12d of cart 12. As shown in FIG. 2, handle 11 has a radius “r” and would have a resulting circumference 2 pi r.

A cover 13, also as described herein a wrapper 13, has a length from one end to another end “A” as shown in FIGS. 3 and 4. This length “A” is greater than the circumference of handle 12, preferably 25% to 50% greater, but may be 50% to 100% greater. Cover 13 has a width “B” FIG. 5 slightly less than the width C of handle 11.

As shown in FIG. 4, cover 13 has a first end 16 and a second end 19. Preferably the length “A” of cover 13 is such that as shown in FIG. 6, first end 16 overlaps second end 19. When cover 13 is provided with a curl, known in the art of paper manufacturing, cover 13 will curl around handle 13 and the ends, end 16 will overlap end 19. Additionally, a releasable adhesive 14 can releasably be used to attach first end 16 of wrapper 13 to second end 19 as shown in FIG. 6. Though FIG. 6 shows use of adhesive 14, with or without the adhesive 14, when the cover 13 has a curl, the ends 16 and 19 will overlap or be in close proximity to each other. Wrapper 13 is constructed and arranged to be secured around handle 11, by attachment of said first end 16 with said second end 19 by said adhesive 14. The inside circumference of closed cover 13 is greater than the circumference of handle 11 such that cover 13 rests on handle 11 in a loose manner depending on the actual length A of cover 13, the amount of open area 20, under handle 11 will increase or decrease.

It is not necessary that secured wrapper 13 be tight against handle 11. It is preferably loosely fitted around handle 11. Preferably the weighted portion of the ends, first end 16, and second end 19, in close attached relationship, would cause the wrapper 13 to align itself, by gravitational pull, such that the heavier, attached portions, in the proximities of first end 16 and second end 19, would be drawn by gravity to rest such that wrapper 13 was orientated with the first end 19 and second end 19 at the bottom or a lower level in relationship to handle 11, see FIG. 6.

As shown in FIG. 6, the top of handle 11 is in contact with the inside portion of wrapper 13 when wrapper 13 is secured around handle 11 with first end 16 attached to second end 19 as heretofore described. In this manner, an advertisement 15, would be in a preferable orientation for the user of a cart to view advertisement 15. It is also possible that an advertisement 15 can be repeating across the entire exposed area of cover 13 such that the advertisement would be visible no matter what position cover 13 is in.

In order to easily dispense handle wrapper 13, it preferably would be placed on a roll as shown in FIG. 3 whereby each handle wrapper 13 would be arranged first end 16 of one wrapper 13 to second end 19 of a second wrapper 13 whereby a user could peel off one handle wrapper 13 at a time. Each handle wrapper 13 would have a first end 16 attached to a second end 19 by adhesive 14. As shown in FIG. 3, first end 16 is available for a user to grab and pull causing a roll to rotate, such that first end 16 of a handle wrapper 13 would be grabbed by a user and pulled until handle wrapper 13 disengages from the next handle wrapper 13 to be grabbed. Each handle wrapper 13 is attached to the following handle wrapper 13 in similar fashion, preferably using adhesive 14.

In one preferred embodiment, handle wrapper 13 is made of paper. A characteristic of handle wrapper 13 is a memory curl of each handle wrapper 13 so that handle wrapper 13 will, after being removed from the roll as shown in FIG. 3, conform in a general shape around handle 11 as shown in FIG. 6. In this manner, when handle wrapper 13 is applied to a handle 11, it can easily be placed over handle 11 and paper wrapper 13, because of its memory curl will conform to the handle even if loosely surrounding said handle as shown in FIG. 6 as heretofore described. In an alternate embodiment, it is not necessary to have adhesive 14, since the memory curl of cover 13 will cause the two ends first end 16 to overlap second end 19. Because of the memory curl, the cover 13 will remain in said curled position with overlapping ends 16 and 19, as shown in FIG. 6, with or without adhesive 14.

As an alternate embodiment, the adhesive 14 as shown in FIG. 8 is in the proximity of first end 16 at the outside portion thereof. It is also possible to have the adhesive 14 at the close proximity to second end 19 at the inner side of wrapper 13. In the alternate embodiment, a similar roll would be arranged as in FIG. 3 but with the adhesive as described in the alternate embodiment and as shown in FIG. 8.

In a second alternate embodiment, the preferred wrapper material 13 could be a plastic, a plastic sheet that has a “curl” memory. Said wrapper is material whether paper, plastic or other material, could be of a range of 0.1 mil inches to 20 mils.

After use, preferably a user will remove the handle wrapper 13 and properly dispose it in a waste can. If the prior user does not do so, the next user can either dispose of the used wrapper 13 or the said next user can use a new wrapper 13 to cover the handle 11 which also has a used cover 13 thereon. There will be sufficient room for subsequent wrappers 13 to cover prior wrappers 13 since the length A of wrapper 13 is greater than the circumference of handle 11. As shown in FIG. 10, a handle 11, with a first prior cover 13 is under a current cover 13 with the prior cover 13 folded at location “F” to allow room for the next cover 13, as shown in FIG. 10.

Although the disclosure set out herein is detailed in order to enable those skilled in the art to practice the invention, the embodiments disclosed herein are to be considered only examples of the invention which may be embodied in other specific structures as well.

Those skilled in the art will recognize that a number of other modifications to the invention are also possible. Accordingly, the invention should not be deemed limited to the specific embodiments described hereinabove and illustrated in the drawings, but instead only by a fair scope of the claims that follow along with their equivalents.

We claim:

1. A system for providing a covering for a handle of a shopping cart comprising:
(a) a holder for a handle covering, wherein said holder individually dispenses a covering; and
(b) a handle covering; whereby the user may individually dispense a handle covering and place the individualized covering on a handle to be covered.

2. The system of claim 1 wherein said covering is coated with an antimicrobial material.

3. The system of claim 1 wherein said covering material is of a width to substantially cover the length of a handle.

4. The system of claim 1 wherein said covering material has a memory curl relative to the handle being covered.

5. The system of claim 1 wherein said handle covering is made of paper or plastic.

6. The system of claim 1 wherein said handle covering has a thickness between 0.1 mill and 20 mils.

7. The system of claim 1 wherein said handle covering has an adhesive on one side.

8. A covering for a handle of a shopping cart, whereby said covering comprises memory curl, and may be individually placed in position to cover a handle.

9. The covering of claim 8 wherein said handle covering is coated with an antimicrobial material.

10. The covering of claim 8 wherein said handle covering is coated with a waterproof material.

11. The covering of claim 8 wherein said covering material is of a width to substantially cover the length of a handle.

12. The covering of claim 8 wherein said handle covering is made of paper or plastic.

13. The covering of claim 8 wherein said handle covering has a thickness between 0.1 mill and 20 mils.

14. The covering of claim 8 wherein said handle covering has an adhesive on one side.

15. A method of covering the handle of a conventional grocery shopping cart, comprising the steps of:
(a) providing a holder which contains a plurality of handle coverings;
(b) dispensing to a user an individualized handle covering with memory curl; and
(c) placing an said individualized handle covering with memory curl on the handle of a shopping cart.

16. The method of claim 15 wherein said handle covering has a thickness between 0.1 mill and 20 mils.

17. The method of claim 15 wherein said handle covering has an adhesive on one side.

18. The covering of claim 15 wherein said handle covering is coated with an antimicrobial material.

19. The covering of claim 15 wherein said handle covering is coated with a waterproof material.
